(19) United States
(12) Patent Application Publication
(10) Pub. No.: US 2015/0290800 A1
(43) Pub. Date: Oct. 15, 2015

(54) METHOD AND SYSTEM FOR DEVELOPING COGNITIVE RESPONSES IN A ROBOTIC APPARATUS

(71) Applicant: OFEK ESHKOLOT RESEARCH AND DEVELOPMENT LTD., Karmiel (IL)

(72) Inventors: Gideon Avigad, Ramat Yishay (IL); Abraham Weiss, Eshchar (IL)

(21) Appl. No.: 14/440,792

(22) PCT Filed: Nov. 5, 2013
(86) PCT No.: PCT/IL2013/050906

§ 371 Date: May 5, 2015

Related U.S. Application Data
(60) Provisional application No. 61/722,251, filed on Nov. 5, 2012.

(51) Int. Cl. B25J 9/16; B62D 57/024

(52) U.S. Cl. CPC B25J 9/162; B25J 9/1674; B62D 57/024; G05B 2219/40373; Y10S 901/01

(57) ABSTRACT

The subject matter discloses a method performed by an artificial entity that comprises a plurality of mechanical elements. The method comprises receiving activity data, said activity data defines an activity to be performed by the artificial entity; receiving restriction input for restricting performance of the artificial entity; working in a restricted mode, said restricted mode is defined by having one or more restrictions applied on the plurality of mechanical elements of the artificial entity according to the restriction input. The method also comprises adapting to the one or more restrictions applied on the plurality of mechanical elements of the artificial entity and performing the activity with the one or more restrictions applied on the plurality of mechanical elements of the artificial entity.

### FIELD OF THE INVENTION

The subject matter relates generally to a method and system of improving cognitive behaviors in a robotic apparatus.

### BACKGROUND OF THE INVENTION

Learning and cognition of robotic systems progressed significantly over the last several years. The major developments were made with respect to the competencies of the robotic systems' artificial brains to learn, conceptualize, perform offline-planning based on anticipation and the like. Different artificial intelligence architectures have been developed, some of which improved the computational brain robustness by embedding ideas inspired from human cognition and by enhancing performance through embodiment. The general practice when training the robots' cognition is to teach the robot to plan, visualize and execute different trajectories while taking into consideration different environmental instances. According to the common approach, the cognitive abilities are enhanced by improving the capabilities of the artificial brain to store data, reason, plan, visualize, and the like.

### SUMMARY

It is an object of the subject matter to disclose a method performed by an artificial entity that comprises a plurality of mechanical elements. The method comprises receiving activity data, said activity data defines an activity to be performed by the artificial entity; receiving restriction input for restricting performance of the artificial entity; working in a restricted mode, said restricted mode is defined by having one or more restrictions applied on the plurality of mechanical elements of the artificial entity according to the restriction input. The method also comprises adapting to the one or more restrictions applied on the plurality of mechanical elements of the artificial entity and performing the activity with the one or more restrictions applied on the plurality of mechanical elements of the artificial entity.

In some cases, the method further comprises allocating resources of the plurality of mechanical elements to at least one mechanical element that is not restricted.

In some cases, the method further comprises receiving environment restrictions that increase the difficulty of the artificial entity in performing the activity of the activity data. In some cases, the adapting to the one or more restrictions comprises adaptations in the operation of at least a portion of the mechanical elements.

In some cases, the method further comprises evaluating the adaptations learnt for improved efficiency. In some cases, the artificial entity is a climbing robot. In some cases, the artificial entity comprises a neural network.

In some cases, the restriction input of a mechanical element of the artificial entity is either working or not working. In some cases, the restriction input of a mechanical element of the artificial entity defines partial performance of the mechanical element.

It is another object of the subject matter to disclose an artificial entity, comprising: an input unit for receiving activity data comprising an action to be performed by the artificial entity; wherein the input unit receives one or more restrictions that simulate an obstacle in the environment or a malfunction of a mechanical element of the artificial entity; an entity processor to command a motor of the artificial entity to perform an activity of the activity data; wherein the motor is a plurality of mechanical elements of the artificial entity.

In some exemplary cases, the artificial entity further comprises an allocation unit to allocate resources of the artificial entity according to the one or more restrictions;

In some exemplary cases, the artificial entity further comprises an evaluation unit to evaluate the artificial entity's performance of the activities with the adaptations.

In some exemplary cases, the artificial entity further comprises a storage to store the adaptations and a performance evaluation. In some exemplary cases, the processor entity commands one or more motors.

### BRIEF DESCRIPTION OF THE DRAWINGS

Exemplary non-limited embodiments of the disclosed subject matter will be described, with reference to the following description of the embodiments, in conjunction with the figures. The figures are generally not shown to scale and any sizes are only meant to be exemplary and not necessarily limiting. Corresponding or like elements are optionally designated by the same numerals or letters.

FIG. 1 shows a method for developing mechanical cognitive responses, according to some exemplary embodiments of the subject matter;

FIG. 2 shows a climbing robot, according to some exemplary embodiments of the subject matter;

FIG. 3 shows a climbing robot in two stages of performing a designated task, according to some exemplary restricted embodiments of the subject matter;

FIG. 4 shows a method for performing a hand reach operation on a climbing robot, according to some exemplary embodiments of the subject matter;

FIG. 5 shows a method performed in an artificial entity to compensate for one or more restrictions, according to some exemplary embodiments of the subject matter;

FIG. 6 shows a method performed in an artificial entity to adapt to one or more restrictions, according to some exemplary embodiments of the subject matter; and,

FIG. 7 shows an artificial entity, according to some exemplary embodiments of the subject matter.

### DETAILED DESCRIPTION

The subject matter relates to a method and system for improving cognitive behavior in a robotic apparatus' through mechanical cognition, according to exemplary embodiments.

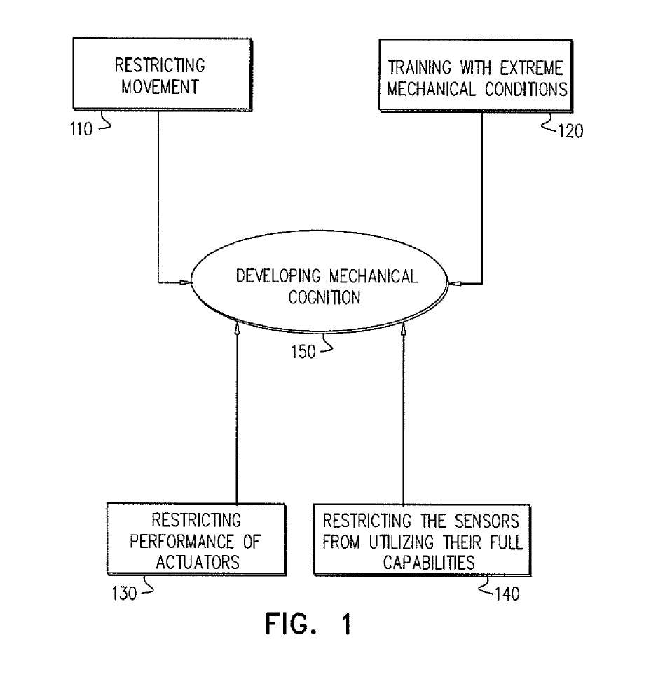

FIG. 1 shows a method of improving cognitive behavior in a robotic apparatus using mechanical cognition, according to exemplary embodiments of the subject matter. Step 110 discloses using only a portion of the robotic apparatus' mechanical capabilities. The robotic apparatus may be restricted from moving some of its mechanical links, for example, if the robotic apparatus has four arms or links, the robotic apparatus is restricted to use only two of the arms or links, or not to use the arm or link gripper. Such limitation may be only for a predefined period of time, or only for a specific task. The robotic apparatus may be restricted from moving the arms or links to less than their full possible extent, or deliberately imposing friction at joints, changing the stiffness of links, or the like. Step 120 discloses restricting the performances of actuators, for example reducing the power supply to the actuators, using weaker actuators, such as smaller motors, or the like. Step 130 discloses training the robot with extreme mechanical conditions such as deliberately positioning weights that effect the location of the center of gravity, using weights to overload the robot, or the like. Step 140 discloses restricting the sensors from utilizing their full capabilities, for example shutting down some of the sensors, slightly changing the robotic apparatus' orientation, or the like. Step 150 discloses updating the cognitive responses of the robotic apparatus. After the robotic apparatus displays capabilities to conduct the designated task under restricted conditions, the robotic apparatus may be switched to full operation mode with no restrictions. The robotic apparatus may then perform the designated task without restrictions. By training the robot in tasks with limited resources and unlimited resources at different times, the robotic apparatus develops robustness to unexpected changes and is able to adapt better to environmental changes as well as to unexpected malfunctioning of its mechanical elements, which leads to improved cognitive responses.

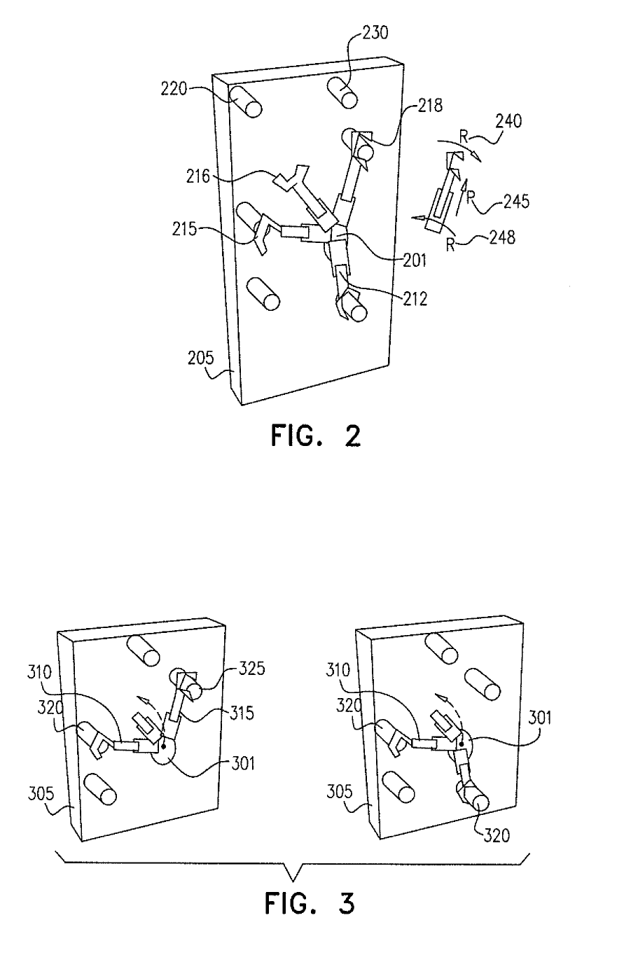

FIG. 2 shows a climbing robot, according to some exemplary embodiments of the subject matter. The exemplary embodiment of the subject matter comprises a robotic apparatus such as a Climbing Robot (“CR”) 201 that has to be trained to climb on a wall 205 with poles sticking out of said wall 205. The CR 201 comprises one or more mechanical resources selected from Rotational base, Prismatic extension-contraction and Rotational gripper links (“RPR links”), for example four RPR links. Each one of the RPR links may comprise a gripper 240 that may rotate and adjust to grab a desired object or to attach to a pole connected to the wall 205. Each one of the RPR links may comprise an extendable limb 245, which allows the CR 201 to extend one of the RPR links to reach for the desired object or to attach to pole connected to the wall 205. Each one of the RPR links may comprise a rotating socket 248, which allows the one of the RPR links to move in multiple angles from the body of the CR 201.

The transition from the non-restricted mode to the restricted mode is embedded within the architecture of the CR 201 and may depend on the addition of sensors to the CR 201 that report on a need to perform in a particular mode of operation. In other cases, the improvement may be achieved by the addition of sensors or modification of sensors' readings, for example via further processing on the same readings of sensors as the restricted mode. For example, the gripper 245 may be closed and does not allow the CR 201 to grasp a designated object, one of the PRP links of the CR 201 is extended to full length and cannot reach the desired object, are indications for a need to move to one of the various restricted modes. The CR 201 does not see the various restricted modes and the unrestricted modes of operation as being different from each other and thus no special extra architecture has to be designed for the CR 201. The various restricted modes and the unrestricted modes of operation may differ in the signals attained from the sensors of the CR 201 and by the actions taken by the CR 201, which are results of sensing-action sequences. In some exemplary embodiments, some moves that may be executed in one of the various non-restricted mode by the CR 201 may not be executed in the one of the various restricted modes. In some cases, one of the various restricted modes may call for redesigning the mechanics of the CR 201 to allow functionality in that one of the various restricted modes.

In some exemplary embodiments of the subject matter, the CR 201 receives commands to attach to a first pole 220 or to a second pole 230. The CR 201 comprises a second link 215 and fourth link 218, which are attaching the CR 201 to the wall 205 on other poles contract while a first link 212 extracts. As the first link 212 extracts, a third link 216 comes within reach of the first pole 220 or the second pole 230. The CR 201 determines the most efficient trajectory, which allows the CR 201 to attach the third arm to either the first pole 220 or the second pole 230, whichever is the most efficient. The CR 201 may determine trajectory efficiency according to the distance required to travel, energy consumption, the number of moves required to complete the trajectory, and the like.

FIG. 3 shows a Climbing Robot (“CR”) 301 in two stages of performing a designated task, according to some exemplary embodiments of the subject matter. FIG. 3 shows a restricted embodiment of the CR disclosed in FIG. 2 that receives the same activity data, climbing the wall. The CR 301 is climbing a wall 305 to which multiple poles are attaches, which allow the CR 301 to climb up the wall 305. In this exemplary embodiment, the CR 301 comprises three PRP links, which the CR 301 uses to climb the wall 305. A first link 310 is attached to a first pole 320 and a second link 315 is attached to a second pole 325. The CR 301 then determines a trajectory wherein the second link 315 moves and attaches to a third pole 330.

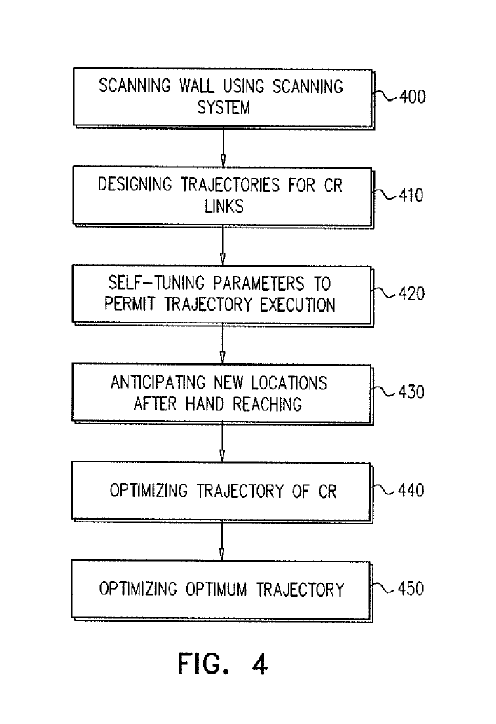

FIG. 4 shows a method for performing a hand reach operation on a climbing robot, according to some exemplary embodiments of the subject matter. Step 400 discloses scanning a wall using a sensing system. The CR 201 comprises a scanning function, which allows the CR 201 to determine the location of potential link poles to which the CR 201 may grip. Step 410 discloses designing trajectories for all links for hand-reaching to the first link pole 220 and the second link pole 230 by utilizing simulations of the CR 201. Step 420 discloses self-tuning parameters in order to permit trajectory's execution. It should be noted that step 420 is exemplary and is not a mandatory step of the method. Step 430 discloses anticipating new locations for hand-reaching after hand-reaching to the first pole 220 or to the second pole 230 and evaluating the new locations with respect to the next needed hand-reach. Step 440 discloses optimizing the trajectory of the CR 201. The CR 201 determines whether to move to the first pole 220 or to the second pole 230. Some of the variables comprising the determination may include energy consumption, distance, number of moves necessary to complete the trajectory, and the like. Step 450 discloses executing an optimum trajectory, which results in a CR 201 trajectory. The CR 201 trajectory is the path which the CR 201 designates as the most optimum based on the variables used to determine the optimum trajectory, and the trajectory which is performed by the CR 201 to complete the designated task.

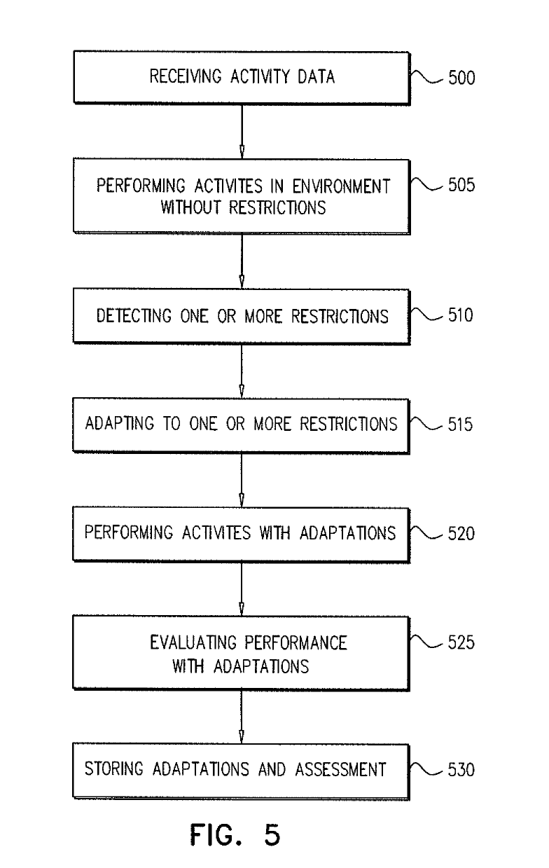

FIG. 5 shows a method performed in an artificial entity to compensate for one or more restrictions, according to some exemplary embodiments of the subject matter. Step 500 discloses the artificial entity receiving activity data. The activity data is defined by an action to be performed by the artificial entity, for example climbing 120 centimeters on a slope of 22 degrees with poles every 25 centimeters. Other activity data may relate to other mechanical operations such as carrying and walking, maneuvering items and the like. Other activity data may relate to electrical operations, such as generating power when the artificial entity comprises elements that are configured to generate power.

The artificial entity may comprise a neural network, which is a computational model inspired by animal central nervous systems, i.e. a brain, that is capable of machine learning and pattern recognition. For example, the neural network comprises three layers of five, five and four tansig (i.e. hyperbolic tangent) activation functions, such as transfer function of orders within the neural network. The output of the neural network may be designated variables, for example, a, b, c, and d, which are manipulating motors of a robotic manipulator. In such cases, the output of the neural network may be represented by the function ax³+bx²+cx+d, as “a*”, “b*”, “c*”, “d*” are the inputs of the neural network. The function enables the artificial entity to correlate the activity data to an environment that is to be learned. For example, the environment received is a function, 0.2x³+(−0.4x²)+0.6x+1. The artificial entity comprises motors of mechanical elements such as artificial limbs or the like that correlate to environment requirements. In some non-limiting exemplary embodiments of the subject matter, the artificial entity is the CR 201 of FIG. 2, which is placed into the environment such as the wall 205 of FIG. 2.

Step 505 discloses the artificial entity performing activities in the environment without restrictions. To begin the learning of the artificial entity, the artificial entity is activated to perform the activity as defined by the activity data without any restrictions and with unlimited resources. For example, the neural network comprises of four inputs, such as “a*”, “b*”, “c*”, “d*”, that correlate to the four outputs “a”, “b”, “c”, “d”, respectively, which are motors to manipulate mechanical elements of the artificial entity. The input provided into the computerized unit of the CR relates to the mechanical elements used by the CR to perform the activity data. The mechanical elements may be limbs of the CR. In case the input of at least one mechanical element is zero (0), the mechanical element will not work and the CR will work on restricted mode. Where there are no restrictions, the computerized unit of the artificial entity is provided an input value of 1, which indicates no restrictions for the motors. An algorithmic representation of no restrictions may be provided by:

$${\sum }_{x = {x}_{1}}^{x = {x}_{400}} Error = min {\sum }_{x = {x}_{1}}^{x = {x}_{400}} ( ( 0.2 {x}^{3} + ( - 0.4 {x}^{2} ) + 0.6 x + 1 ) - ( {ax}^{3} + {bx}^{2} + cx + d ) )$$

For example, all mechanical elements of the artificial entity function at full capacity or no obstacles in the environment prevent the artificial entity's performance. The artificial entity is enabled to perform activities in the environment, such as the CR 201 climbs the wall 205 where all limbs of the CR 201 are functioning. The environment provided enables easy movement for the CR 201 as the wall 205 comprises sufficient number of poles to enable the CR 201 to easily climb up and down the wall 205. The artificial entity performs the activity until the artificial entity is familiar with the environment and the activity to be performed.

Step 510 discloses the artificial entity receiving one or more restrictions. Receipt of the restrictions is a portion of a training stage applied on the artificial entity. The artificial entity receives one or more restrictions via its computerized unit that are caused from an obstacle in the environment or a malfunction of a mechanical element of the artificial entity. The one or more restrictions may comprise environment restrictions that increase the difficulty of the artificial entity in performing the activity of the activity data, for example removing a pole from the wall, changing the slope of the wall and the like. For example, one of the inputs into the computerized unit is changed from an input of one to an input of zero, which turns off a motor that controls a limb of the artificial entity. The artificial entity now only has three mechanical elements that can be used and still be able to perform the activity as best as possible in the environment. For example, input “a*” is designated a value of zero in the neural network example of step 505. This causes mechanical element “a” to stop working. The artificial entity detects that motor “a” is no longer working.

Step 515 discloses the artificial entity adapting to the one or more restrictions. In cases where the one or more restrictions are a result of internal malfunctions, the artificial entity designates resources to motors that are functioning. Such resources may be power, tasks and responsibilities, communication capabilities, sensors and the like. Continuing the example from step 510, the artificial entity adapts to the resources by determining the best way to function with only three mechanical elements while performing the activity in the environment.

Another non-limiting example, where one of the mechanical elements of the CR 201 breaks or is not responding to commands, the CR 201 designates resources to the remaining mechanical elements to compensate for the mechanical element that is not working. In cases where the one or more restrictions arise from environmental inhibitors, the artificial entity designates resources to most efficiently overcome the environmental inhibitors. For example, where the CR 201 is climbing the wall 205 and reaches a location on the wall 205 where no pole is available to grab on, the CR 201 designates the resources to move in a new direction, for example of the nearest available pole that allows the CR to move forward. In some other exemplary cases, the CR may perform another maneuver. Such another maneuver would not have been used if restricted mode learning was not performed. The artificial entity in such a manner adapts the performance to continue performing in the most efficient manner possible.

Step 520 discloses the artificial entity performing the activities with the in a restricted mode, with adaptations. Once the artificial entity adapts by designating the resources in a necessary manner, the artificial entity performs a desired activity. Using the example of the neural network of the previous steps, the artificial entity performs the activity in the environment where only three mechanical elements are functioning while still attempting to best perform as originally commanded. In accordance with another non-limiting example, once the CR 201 determines that one of the mechanical elements is no longer functioning, the CR 201 allocates resources of the non-working mechanical elements to working mechanical elements, such as power to the other limbs to enable them to continue climbing the wall 205 without requiring the performance. Step 525 discloses the artificial entity evaluating the artificial entity's performance of the activities with the adaptations. The method of the subject matter also comprises a step of evaluating the performance of the artificial entity to determine a level of efficiency of its performance. Such evaluation may be performed independently by the artificial entity or by an external unit. Such evaluation may be performed during performance, in real time, or after the performance terminates.

Step 530 discloses the artificial entity storing the adaptations and the performance evaluation. In some exemplary embodiments of the subject matter, the artificial entity is trained to be prepared for different situations that may occur, as different situations represent various restrictions of the mechanical elements and of the environment. For example, in the neural network example of the previous steps, the artificial entity operated having an input of zero only for a single mechanical element. This results that each time one of the inputs is provided a zero value the designated motor does not function. This enables training the artificial entity to operate when each individual mechanical element is not functioning. The artificial entity is then able to perform in the future when similar restrictions occur. Once all mechanical elements are trained in such a way the artificial entity stores all adaptations learned for future use when faced with similar restrictions. In some cases, after the artificial entity has learned to perform where one motor is not functioning, the artificial entity is trained to perform where two mechanical elements are not functioning and when three mechanical elements are not functioning.

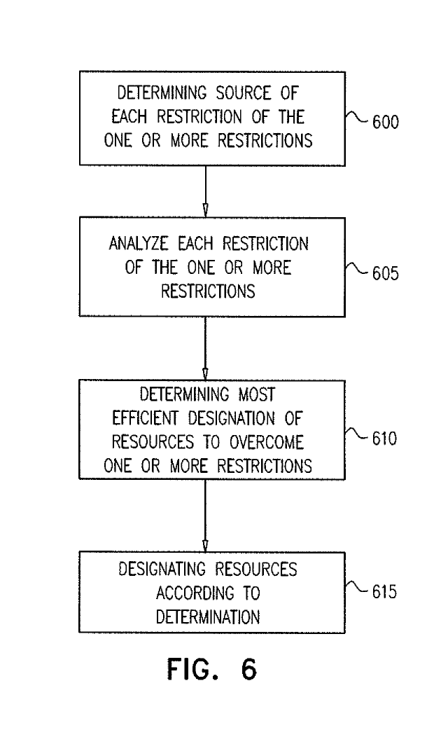

FIG. 6 shows a method performed in an artificial entity to adapt to one or more restrictions, according to some exemplary embodiments of the subject matter. Step 600 discloses the artificial entity identifying a source of a restriction of the one or more restrictions. The artificial entity prompts a command to perform some activity, for example, the third link 216 of FIG. 2 of the CR 201 of FIG. 2 is broken. The CR 201 transmits a command to the third link 216 of FIG. 2 to reach out and grab the first pole 220, which is not performed. The CR 201 determines there is some malfunctioning in the third link 216 which prevents the third link 216 from performing the command.

Step 605 discloses the artificial entity analyzing each restriction of the one or more restrictions. The artificial entity analyzes the error to determine the source of the error. For example, the CR 201 determines that the error occurred because the third link 216 is not responding to commands and is therefore malfunctioning.

Step 615 discloses the artificial entity determining an efficient designation of resources to overcome each restriction of the one or more restrictions. Step 620 discloses the artificial entity designating the resources according to the determination. For example the artificial entity comprising of four limbs where one limb is not functioning, increases the resources of each limb from 25% use of the resources to 33% of the resources. This enables each limb to function as to compensate for the one non-functioning limb.

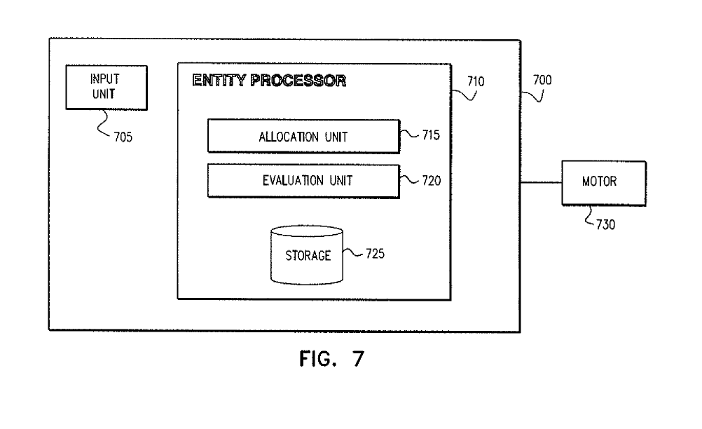

FIG. 7 shows an artificial entity, according to some exemplary embodiments of the subject matter. The artificial entity 700 comprises an input unit 705, which receives input data. The input data received by the input unit 705 comprises activity data, which is defined by an action to be performed by the artificial entity 700. In some cases, the input unit 705 receives one or more restrictions that simulate an obstacle in the environment or a malfunction of a mechanical element (not shown) of the artificial entity 700. The one or more restrictions may comprise environment restrictions that increase the difficulty of the artificial entity in performing the activity of the activity data, for example removing a bolt from the wall, changing the slope of the wall and the like.

The input unit 705 transfers the input data to an entity processor 710. The entity processor 710 designates performance requirements to a motor 730 in accordance with activity data received from the input unit 705. The motor 730 manipulates a mechanical element according to the performance requirements received from the processor 710. In some exemplary embodiments of the subject matter, the artificial entity comprises one or more motors, which receive activity commands from the processor 710. In some cases, the motor 730 manipulates a plurality of mechanical elements. The entity processor 710 comprises an allocation unit 715, which allocates resources of the artificial entity 700 according to the one or more restrictions. When the artificial entity 700 encounters one or more restrictions that limit the functioning of the motor 730, for example by one of the mechanical elements of the plurality of elements not functioning, the allocation unit 720 allocates resources so the working mechanical elements perform as required. In other cases when one of the one or more motors is restricted, the allocation unit 720 allocates resources to working motors to compensate for the nonworking mechanical element.

The entity processor 710 comprises an evaluation unit 720, which evaluates the artificial entity's performance of the activities with the adaptations. The artificial entity 700 to determines a level of efficiency of its performance while using the adaptations that enable the artificial entity 700 to overcome the one or more restrictions. The evaluation may be performed during performance, in real time, or after the performance terminates. The artificial entity 700 comprises a storage 725 to store the adaptations and a performance evaluation. The artificial entity 700 is trained to be prepared for different situations that may occur, as different situations represent various restrictions of the mechanical elements. Once the artificial entity 700 has stored the adaptations and the performance evaluation, the artificial entity 700 may use the stored adaptations to perform when similar restrictions occur.

While the disclosure has been described with reference to exemplary embodiments, it will be understood by those skilled in the art that various changes may be made and equivalents may be substituted for elements thereof without departing from the scope of the subject matter. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this subject matter, but only by the claims that follow.

1. A method performed by an artificial entity that comprises a plurality of mechanical elements, the method comprises:
receiving activity data, said activity data defines an activity to be performed by the artificial entity;
receiving restriction input for restricting performance of the artificial entity;
working in a restricted mode, said restricted mode is defined by having one or more restrictions applied on the plurality of mechanical elements of the artificial entity according to the restriction input;
adapting to the one or more restrictions applied on the plurality of mechanical elements of the artificial entity;
performing the activity with the one or more restrictions applied on the plurality of mechanical elements of the artificial entity.

2. The method of claim 1, further comprises allocating resources of the plurality of mechanical elements to at least one mechanical elements that is not restricted.

3. The method of claim 1, further comprises receiving environment restrictions that increase the difficulty of the artificial entity in performing the activity of the activity data.

4. The method of claim 1, wherein adapting to the one or more restrictions comprises adaptations in the operation of at least a portion of the mechanical elements.

5. The method of claim 4, further comprises evaluating the adaptations learnt for improved efficiency.

6. The method of claim 1, wherein the artificial entity is a climbing robot.

7. The method of claim 1, wherein the artificial entity comprises a neural network.

8. The method of claim 1, wherein the restriction input of a mechanical element of the artificial entity is either working or not working.

9. The method of claim 1, wherein the restriction input of a mechanical element of the artificial entity defines partial performance of the mechanical element.

10. An artificial entity, comprising:
an input unit for receiving activity data comprising an action to be performed by the artificial entity; wherein the input unit receives one or more restrictions that simulate an obstacle in the environment or a malfunction of a mechanical element of the artificial entity;
a processor entity to command a motor of the artificial entity to perform an activity of the activity data;
wherein the motor is a plurality of mechanical elements of the artificial entity.

11. The artificial entity of claim 10, further comprises an allocation unit to allocate resources of the artificial entity according to the one or more restrictions.

12. The artificial entity of claim 10, further comprises an evaluation unit to evaluate the artificial entity's performance of the activities with the adaptations.

13. The artificial entity of claim 10, further comprises a storage to store the adaptations and a performance evaluation.

14. The artificial entity of claim 10, wherein the processor entity commands one or more motors.
